(19) United States
(12) Patent Application Publication
(10) Pub. No.: US 2008/0257178 A1
(43) Pub. Date: Oct. 23, 2008

(54) Radial Screen Printing Machine

(76) Inventor: Manuel Silva Correia De Sa, Riba De Ave (PT)

Correspondence Address: WENDEROTH, LIND & PONACK, L.L.P., 2033 K STREET N. W., SUITE 800, WASHINGTON, DC, 20006-1021, US

(21) Appl. No.: 11/662,763

(22) PCT Filed: Sep. 14, 2005
(86) PCT No.: PCT/IB2005/002719

§ 371 Date: Jun. 17, 2008

(30) Foreign Application Priority Data
Sep. 14, 2004 (PT) 103192

(51) Int. Cl. B41F 15/08

(52) U.S. Cl. 101/126

(57) ABSTRACT

The present invention relates to a radial screen printing machine, in particular for textile application, machine that is provided with printing stations (1) and is characterised in that it has a relative movement of angular lifting/lowering (13), between the stations and the correspondent platforms (8), whose operation is not promoted by actuators supported in towers and in that the relative angular positioning (considering a plane orthogonal to the axis of the machine) between the said stations and the referred platforms (8)—these connected to a rosette (7) that can turn in relation to the base (6) set on the soil (9)—is obtained without resorting to towers. The articulation (25) is constituted by a plate susceptible of flexing, fixed to the support (2) and to the station. A rod (12) articulates in each station and in another mobile point, in a column (20), to which is imposed a movement (27) between two positions (28, 29). It is foreseen a mechanism of over-elevation of the stations.

### TECHNICAL FIELD/APPLICATIONS

This invention concerns an automatic printing machine, namely of the type of those provided both with platforms of support of the articles to work, disposed radially around the axis of the machine and susceptible of pivoting around said axis, and with printing heads also disposed radially, which are destined to print the articles supported in the said platforms. In particular the invention concerns the way of elevation of the printing heads. The preferential field for application is in the printing or stamping out of textiles, although it may be applied for other purposes.

### STATE OF THE ART

1—Principal Types of Existing Machines and Approach of their Inconvenients

Although there is a profusion of models of printing or stamping machines, even for the case of the printing or stamping of individual textile articles, the present analysis will have incidence on the devices that make the application of product (namely paint) through several printing stations or heads that apply product individually, since that is the generalised operation principle, being also the one of the device according to the invention.

In each station is promoted the application, by serigraphic process, of a quantity of product over a part of the surface of the individual article, accordingly to the form defined in the serigraphic screen.

Depending on the various types of products or colours that are supposed to apply, the article is made go through successively by as many independent stations as the distinct products or colours in question.

Although the various existing machines aim to implement the above indicated process, they do it in the most varied ways. Even in the particular case of the machines of the type of the ones to which the present invention respects, that is, in which both the platforms of support of the articles and the printing stations are disposed radially around the axis of the machine, there are substantial operation differences.

However, once an article is placed to print over a support platform and this platform is placed aligned underneath the first printing station or head, all these machines have to implement, al least, the following:
an approach movement that places the article to stamp out in contact with the serigraphic screen of the station aligned with it;
an inverse movement after the application of the product in that station;
a rotation movement (around the axis of the machine) that places the article under the following station; and
so on successively, until the article goes through the last station.

The way by which the movement of axial approach has been implemented, as well as the way by which the rotation has been implemented, in order to align the printing heads and the support platforms, have been the most varied.

However, regardless of the specific implementations, the radial screen printing machines may be divided into two major groups:
those in which both the rotation movement and the axial movement of approach/retreat between the articles to stamp out and the serigraphic screens are both imposed to the set of platforms of support of the articles, named star;
those in which only the star is subject to the rotation movement, said axial approach/retreat movement being imposed on the printing heads (together or individually).

In U.S. Pat. No. 6,408,745 is described a radial screen printing machine of the type of those of the first group aforementioned. In fact, the star functions not only as a rotor, allowing the various platforms of support of the articles to position sequentially in aligned fashion with each one of the printing stations or heads, allowing also to lift or lower such platforms so that the correspondent articles come first in contact with the serigraphic screens for the application of the product and afterwards cease the contact with such screens in order to allow the subsequent rotation until the next printing station. In particular, are foreseen means of compensation of the weight of the star in order to allow the use of actuators with less power, as well as means of regulation of the amplitude of the axial movement.

In turn, in U.S. Pat. No. 5,784,956 is described a radial screen printing machine of the type correspondent to the second group. In fact, in the machine described there the star where are fixed the platforms of support of the articles to be stamped out revolves only around its axis, not translating. The translation movement according to the referred axis, by means of which is obtained the approach or retreat between the serigraphic screens of the printing stations or heads and the platforms of support of the articles to print out, is imposed to the said stations by the respective central support to which is applied such translation movement. In this document the attention is directed, in particular, to the need of accuracy in the positioning of the angular movement of the star in order to be able to guarantee the necessary printing quality in the case of the polychromatic printing—in particular in the case of the successive monochromatic printing, with different colours, of motives with adjacent contours—as well as to the need to make compatible such accuracy with high speeds of transference of the articles between the printing stations in order to be able to obtain high cadences of operation and an adequate productivity.

In U.S. Pat. No. 5,913,264 is described another radial screen printing machine, being described, in particular, multiple configurations for said machine, namely of the type of the ones of the first group previously indicated, as well as of the second. The accuracy of the relative positioning between the printing heads and the support platforms is, also in this case, one of the problems considered, being reflexively also the manufacture problems related with the inherent needs of accuracy of the machining of the surfaces of the central shaft, both for the star's rotation movement and for the translation movement, either of this one, or of the support of the printing heads. In particular, is foreseen a sliding path relatively distant from the central axis. The problem of the efforts for the lifting is also approached being foreseen the lifting by means of the use of a plurality of elements radially disposed and relatively distant from the vertical central axis of the machine. The question of the adjustment of the relative positioning between the working stations and the platform of support of the articles is approached by way of the use of a series of abutments existent between the central support of the stations and the central support of the star of platforms of support of the articles. On the other hand, in that document is made an approach to the state of the art fairly exhaustive revising and criticising the principal types of existent devices.

In particular, is analysed there the case of radial screen printing machines in which the star is only provided with rotation movement around the vertical axis of the machine and in which the movement of relative approach between the printing heads or stations and the platforms of support of the articles is promoted by the lifting of the printing heads, not in translation but rather by rotation around axes orthogonal to the vertical axis of the machine. Two possibilities are referred there: in one, the articulation of the stations occurs in a central support of the machine; and, in the other, the articulation occurs in some towers disposed radially around the machine.

The second possibility referred there presents the inconvenient that the towers constitute a factor of obstruction, besides making difficult to the operator of the machine the visualisation of the way in which the printing is being carried out or, more generically, the stamping out or application of the product. Regarding the first possibility mentioned, practise has shown that the plays introduced by the articulation of the stations in the central support introduced a new factor of misalignment between the relative angular positioning between the stations and the correspondent platforms, not being guarantee, thus, the necessary accuracy, since the abutments are disposed in the zone corresponding to the central support of the stations, that is, upstream of the introduction of this new misalignment. Consequently, in practice, the machines with a design accordingly to that second possibility have also been subject to the use of radial external towers destined to guarantee the correct positioning of the extremities of the printing heads, thus compensating any eventual misalignment resulting from the play in the articulation between the heads and the correspondent central support, said tower originating, however, the mentioned obstruction problems, besides involving a higher complexity of the machine.

### 2—Careful Examination of the Principal Inconvenients

For a better understanding both of the general operation principles of the radial screen printing machines and of the respective problems, said principles and problems are explained concisely hereunder based on the FIGS. 1 to 8, where:

FIG. 1 corresponds generically to a side schematic view of a machine of the category in which is included the machine described in the mentioned document U.S. Pat. No. 5,784,956;

FIG. 2 corresponds generically to a plan view of a radial screen printing machine provided with towers;

FIG. 3a represents, in orthogonal projection, a plan view of a platform of support of an article and of the respective printing head; FIG. 3b represents, also in orthogonal projection, the correspondent side view; and FIGS. 3c-e, represent identical side views, showing a sequence of phases of the ungluing between the printing head and the article and correspondent support platform;

FIG. 4 represents schematically the efforts to overcome to obtain the ungluing between one printing head and the correspondent support platform of the article, promoted by translation orthogonal to the plan of union;

FIG. 5 represents the situation correspondent in the case of the ungluing promoted by the lifting, pivotally, of the head relatively to the platform of support of the article;

FIG. 6 represents schematically a side view of a type of machines existent in the market—mentioned above in the comments made about the cited document U.S. Pat. No. 5,913,264—more particularly where is made use of radial external towers guarantee the alignment of the free top of the correspondent printing head;

FIG. 7 represents schematically, in plan, the oscillation of a printing head, typical of the machines of the state of the art (when are not used radial external towers for alignment); and

FIG. 8 represents schematically the deviation resulting in a printing made in two successive stations, in case of oscillation of the printing heads.

As is verified by FIGS. 1 and 2, a radial screen printing machine or a screen printing machine in carrousel, as is also commonly named, is constituted by a base (6), from which exits a vertical shaft (3) integral with a support (2). To the support (2) are fixed, radially disposed, diverse stations (1), normally serigraphic stations constituted by printing heads, in which each one of these has, generically—as is better visualised in FIG. 3—a screen frame (15) for support of a serigraphic screen (16) and of a set of serigraphic blades (4) susceptible of making an alternate translation movement over the said screen in order to impel the product (normally paint) through the porous part of the screen (that corresponds to the motive (19) or part of the motive that is to be printed in that station, which is previously imprinted in the said screen) when that screen is in contact with the article (17) to print, which is provisionally glued to the correspondent support platform (8)—by means of an adhesive substance (18) previously spread on the said platform—platform that, in turn, is radially fixed to a rosette or star (7).

In the machines of the type of the ones represented in FIGS. 1 and 2 the star (7) may rotate around the axis (3), on top of which is fixed the support (2) to which are rigidly fixed the stations (1) that, consequently, are immobile regarding the soil (9), forming a single body with the said support (2) after being fixed to it.

Normally each machine is provided with various printing stations (1) fixed to the support (2), being also provided with a correspondent set of platforms (8)—for support of the articles to print—rigidly fixed to a star (7), forming a carrousel as may be observed in FIG. 2. Both the number of stations and the number of platforms is variable, accordingly to the model of the machine or the number of colours intended, the number of platforms either coinciding with the number of stations or being higher than that number, situation that occurs frequently and is visualised in FIG. 2.

Its operation is processed in the following way:

The star (7) and the correspondent platforms (8) being in the lowest position regarding the soil, an article (17) is placed over a first platform (8), article that is provisionally glued to said platform—due to the adhesive substance (18) previously spread in it—after which (manually or automatically) the star is impelled to rotate until that platform is duly placed under a first station (1), time at which the star performs its translation movement (5) in the ascendant sense, the platforms that support the articles being at the level of the heads (1) and in printing position. Then, in each station (1), is simultaneously applied the paint or product to the article (17) through serigraphic blades (4). Afterwards, the star returns to the lower position, through the translation movement (5) in the descendent sense, restarting a new cycle. Thus, the articles that are placed in the platforms (8) are successively passed through the various stations (1) and the paint or product intended, namely with diverse colours or properties, are applied to them, in each one of these stations.

Likewise, it is possible to have a functioning similar to this one, in which the height of the star (7) regarding the soil (9) is fixed and is the support (2) that makes the translation movement (ascendant/descendent), forcing the stations (1) to lift/lower. It is the case, for example, of the device of the state of the art illustrated in FIG. 1A of the cited document U.S. Pat. No. 5,913,264.

The provisional gluing of the article (17) to the respective platform (8) is destined to insure the stability of its positioning, which is vital, since, in case of displacement of the article relatively to the respective platform, when this would transit to the subsequent station for application, for example, of a new colour that ought to be contiguous to the one(s) already applied previously, there would be unwanted overlapping and/or spacing between the colours.

Ungluing Problem

The machines that have been described, in which the ascendant/descendent movement of the platforms or of the stations is a vertical translation movement, revealed, in practice, certain problems and inconvenients related with the ungluing between the serigraphic screen and the articles and correspondent platforms.

As was observed above, each article (17) is provisionally glued to the respective platform (8) by an adhesive substance (18), frequently happening that this adhesive substance is spread in an area that goes beyond, at least in certain points, the contour of the said article (please see FIG. 3). Consequently, when the serigraphic screen (16) of the screen frame (15) of the printing head (1) comes in contact with the article and, due to its flexibility, also with the correspondent platform, it ends up by being temporarily glued by the said adhesive substance. Moreover, once the product (19) (generally paint) is applied to the article (17), by the serigraphic station (1), application that occurs through the net of the said screen—due to the action of the pressure and of the swinging movement of the serigraphic blades (4)—the screen gets adhered directly to the article, adherence that is as higher as higher is the area of application of the product and the more the characteristics of the applied product have adhesive qualities, which is common in the type of products applied.

When, ended the application of the product (19), the station (1) and the correspondent platform (8) with the article (7)—this with the product (19) applied recently—distance from each other, the serigraphic screen (16) is submitted to an effort of ungluing, as is illustrated in the FIGS. 3c-e that represent schematically the ungluing sequence, resulting from the parallel ungluing movement (23).

That sequence shows (in FIG. 3c) the screen frame (15) and the respective screen (16) above the article to be printed and with the screen (16) in contact with the glue (18), the article (17) being involved by the said screen due to its (16) flexibility. Such flexibility combined with the pressure exercised by the serigraphic blades, makes the screen to be in contact with the adhesive substance (18) and glued to it. When the frame (15) and the platform (8) distance from each other (see FIG. 3d) the screen, due to its elasticity, still remains glued to the article and to the adhesive substance offering resistance to that spacing apart. The increase of the spacing apart ends up by provoking an ungluing force in the connection of the screen to the article and to the glue, that leads to the freeing of the said screen (see FIG. 3d). However, sometimes, an excessive effort provokes damages in the screen (16) (with the inherent stops in the production for application of the necessary corrective measures) or leads really to the plucking (total or partial) of the article (17) from its platform—namely in the cases in which the adhesive characteristics and/or the area of application of product (19) in the article originate a higher adherence relatively to the screen, than the adherence promoted between the said article and its respective platform (8) by the adhesive substance (18)—which originates production flaws and/or stops in the production.

Although it is always necessary to apply a bigger or lesser effort to liberate the screen from the correspondent article, it is clear—as may be verified by the FIGS. 4 and 5—that the problem of the eventual ungluing of the article and/or damaging of the screen is more pressing when the spacing apart between the screen frame and the platform occurs according to a translation movement orthogonal to the respective parallel plans (FIG. 4), since the simultaneous efforts for the detachment of each part of the screen are added, being less critical in the cases in which, for example, the printing head is distanced from the platform by the angular lifting (FIG. 5), considering that in this case there is a gradual ungluing of the screen momentarily limited only to a restrict strip.

So, regarding the problem of the ungluing, the machines of the type of the ones represented in FIG. 6 present advantages over the ones of the type represented in FIG. 1.

Problem of the Misalignment

However, the machines of the type of the ones represented in FIG. 6 are more problematic regarding the question of the misalignment, which forces, in practice, to have to resort to the said alignment towers (11).

In this type of machines, the star (7) is placed at a fixed distance from the soil (9), not moving in the vertical sense, rather having only a horizontal rotation movement around the axis (3). The printing stations are connected to the support (2) of the machine by plane articulations (25)—configured as conventional hinges with a shaft acting as fulcrum—being guided in the zone of the correspondent external tops by supports exterior to the machine, denominated towers (11).

Each one of those towers (11) is provided with an actuator (10) that allows to elevate the exterior top of the correspondent station (1), forcing this one to make an angle with the correspondent platform (8) and, in general, with the star (7).

The star (7) makes the rotation of the carrousel, station by station, so that, in each move forward, each article stays in the position of application of paint in the respective station, the cycle repeating successively until all the colours are printed.

Although the problem of the misalignment is not exclusive of the printing machines of the type of the ones of FIG. 6, as it may occur in the ones of the type of FIG. 1—namely owing to incorrect positioning of the star (7) in relation to the stations (1)—the fact remains, as was referred before, it has higher acuteness in those machines, namely because the conventional plane articulations (25), not being free from plays, make possible the misalignment of the correspondent stations.

In fact, as may be observed in FIG. 7, any play, in the plane articulation (25), between one station (1) and the support (2), allows an angular misalignment of the said head in relation to its theoretical position, either to one side, or to the other, angular misalignment that even being small, due to the significant length of the stations, represents very important deviations (24) in the exterior extreme of said head.

The result of those deviations (24) is the production of defects, as is illustrated, merely as example, in FIG. 8, for a case in which, by hypothesis, it was intended to achieve the overlapped printing of two distinct products, one represented in a continuous line and the other in discontinuous line. Thus, on the left, is represented the case of a correct printing in which the deviation/shift (24) is null and, on the right, is represented the defect (that is, the non-overlapping of the products, contrarily to the intended in the considered hypothesis).

To avoid it, in the traditional machines is radially placed, aligned with each station, a tower (11) that permits to reduce the deviation (24) resulting from the effect of the play of the plane articulations (25) of the printing head to an almost null value, since they represent a second support point for the head, not allowing it to oscillate laterally. However, as referred above, the heads represent not only an additional factor of obstruction (both in the merely dimensional aspect and also regarding the access, by the operator(s), to the printing zone in each station), but also increase the complexity of the machine and of the correspondent assembly in the place of use of said machine.

From all the above mentioned, it is verified that there is interest in having a machine in which the problems of ungluing and of misalignment are minimised, without however having to resort to alignment towers (11).

### DESCRIPTION OF THE INVENTION

According to the invention, that is achieved by means of a radial screen printing machine, provided with radially disposed printing stations, characterised in that has a relative angular movement of lifting/lowering, between the stations and the correspondent platforms, whose operation is not promoted by actuators supported in towers and in that the relative angular positioning—considering a plane orthogonal to the axis of the machine—between the said stations and the same correspondent platforms, is obtained without resorting to towers.

According to a particular embodiment of the machine this is characterised in that the stations are operated together, regarding its angular lifting/lowering movement.

According to another particular configuration of the said machine this is characterised in that the stations are operated individually, regarding its angular movement of lifting/lowering.

The suppression of the alignment towers collides, namely, with two difficulties: on one hand, the difficulty in maintaining the necessary printing accuracy when are adopted configurations that allow the angular lifting of the stations destined to minimise the ungluing problems (actually, it was for the guarantee of that accuracy that, in the machines of the state of the art, were precisely adopted such towers) and, on the other hand, the need to provide the operation of the angular lifting of the stations without resorting to such towers, when, traditionally, the operation of the angular lifting/lowering of the stations is made precisely from the said towers.

Accordingly to a preferential embodiment of the machine according to the invention, this is characterised in that the plane articulation, between each station and the support, is constituted by a plate susceptible of flexing rigidly fixed, by the zone correspondent to the respective extremities, to the said support and to the station, plate essentially not susceptible of being deformed, except for the bend around an axis parallel to the plane of the respective faces and orthogonal to the radial direction corresponding to the station. The plane articulation thus configured is substantially devoid of lateral plays guaranteeing the necessary accuracy thus making unnecessary the use of alignment towers.

According to another preferential embodiment of the machine of the invention, this is characterised in that the angular lifting/lowering movement of each station is promoted by a correspondent rod that articulates in the said station and in another point (fixed or mobile) connected to the support of the stations.

In a particularly preferential way, this other point is mobile, promoting the displacement of the correspondent rod and consequently the movement of the respective station.

In the alternative configurations in which this point is fixed, each rod has to have a variation mechanism of the correspondent length, and so the machine will be of the type of the aforementioned as being of individual operation of the stations.

In compensation, in the said preferential configurations in which the referred point is mobile, the movement of this point will be made along a line in the plane that contains the radial axis of the station and the axis of the rod.

In particular, such movement may be made along lines orthogonal to the central axis of the machine or along lines parallel to this same axis. In the first case, the machine will also forcibly be (except if are used additional components) of the type of the aforementioned machines having the stations individually operated, but, in the second, it may either be of this type, or, alternatively, of the type previously referred as having the stations operated together. In this last case, the operation of the stations, regarding its angular lifting/lowering movement, will correspond, in general, to the functioning of an inverted umbrella. This last configuration has the advantage of allowing the use of only one actuator for the various stations.

Accordingly to another particular embodiment of the machine according to the invention, one or more stations—preferentially all—have an individual mechanism of over-elevation. Such mechanism increases the versatility of the machine, making easier, namely, inspection and cleaning operations of the stations, as well as the selective deactivation of certain stations.

In particular, the over-elevation mechanism promotes either the spacing apart between the points correspondent to the plane articulation between the station and the support and to the articulation between the same station and the correspondent rod, or the shortening of the said rod, or still the adequate movement of the point corresponding to the other articulation of the rod.

### DESCRIPTION OF THE DRAWINGS

Besides FIGS. 1 to 8 already presented before and referring, generally, to the state of the art, are now presented, as mere non limitative examples, drawings illustrative of the machine according to the invention.

Such drawings are based in one or more of the indicated embodiments, but do not intend to be exhaustive. In particular, all of them refer to the specific case in which the relative angular lifting/lowering movement between the stations and the correspondent platforms is implemented based on the stations, the platforms not being provided with any angular movement of lifting or lowering. However, as results from the aforesaid, the inverse situation would also be possible without departing from the scope of the invention.

So, such movement could be implemented in the platforms, the stations being fixed. In this case, the plane articulations described previously, implemented with base on plates susceptible of flexing, would be inserted between the rosette and each one of the platforms. In what concerns the embodiments indicated previously in which is made use of rods, these would articulate in the said platforms and in another point (fixed or mobile) relatively to the said star.

Likewise, regarding the relative angular movement between the stations and the platforms considering a plane perpendicular to the axis of the machine, although the drawings presented refer to the case in which the same is implemented exclusively based on the rotation movement of the star, the inverse situation, that is, an immobile rosette and the stations susceptible of rotating in the plane, could also be implemented without departing from the scope of the invention. Likewise in what concerns any combinations of the possibilities described previously.

The FIGS. 9 to 16 illustrate the following:

FIG. 9, corresponds generically to a side view of a station provided with a plane articulation and with a rod, both accordingly to the established in the particular forms of embodiment of the invention;

FIGS. 10 and 11 represent, schematically, the operation principle of said articulation;

FIG. 12 represents the upper part of a machine accordingly to the invention, as well as an expanded detail of the correspondent plane articulation between a station and the respective support;

FIGS. 13 and 14 illustrate examples of embodiment of the machine according to the invention, with individual operation of the stations and with operation of the stations as a set, respectively;

FIG. 15 corresponds to FIG. 12, but the details represented in a larger scale respect now to the over-elevation mechanism; and

FIG. 16 corresponds to FIG. 9, but illustrates additionally the operation of the over-elevation mechanism.

### DETAILED DESCRIPTION OF THE INVENTION

Afterwards, is made a more detailed description of the present invention, based on the cited figures, where the elements expressly referenced therein are:
1—stations;
2—support;
3—vertical axis;
4—serigraphic blades;
5—translation movement;
6—base;
7—rosette or star;
8—platform of support;
9—soil;
10—actuator;
11—alignment towers;
12—rods;
13—angular lowering or lifting movement;
14—plate;
15—screen frame;
16—serigraphic screen;
17—article;
18—adhesive substance;
19—motive or product;
20—column or central support;
23—parallel ungluing movement;
24—deviations;
25—plane articulations;
27—movement of the point of articulation of the rod (not being on the station);
28—first position of the point of articulation of the rod (not being on the station);
29—second position of the point of articulation of the rod (not being on the station);
30—supplementary movement of angular lowering or lifting;
31—guide;
32—extreme of the guide;
33—extreme of the guide;
34—closing lever;
35—fulcrum of the lever;
36—arc or movement of rotation of the lever;
37—groove;
38—angular difference.

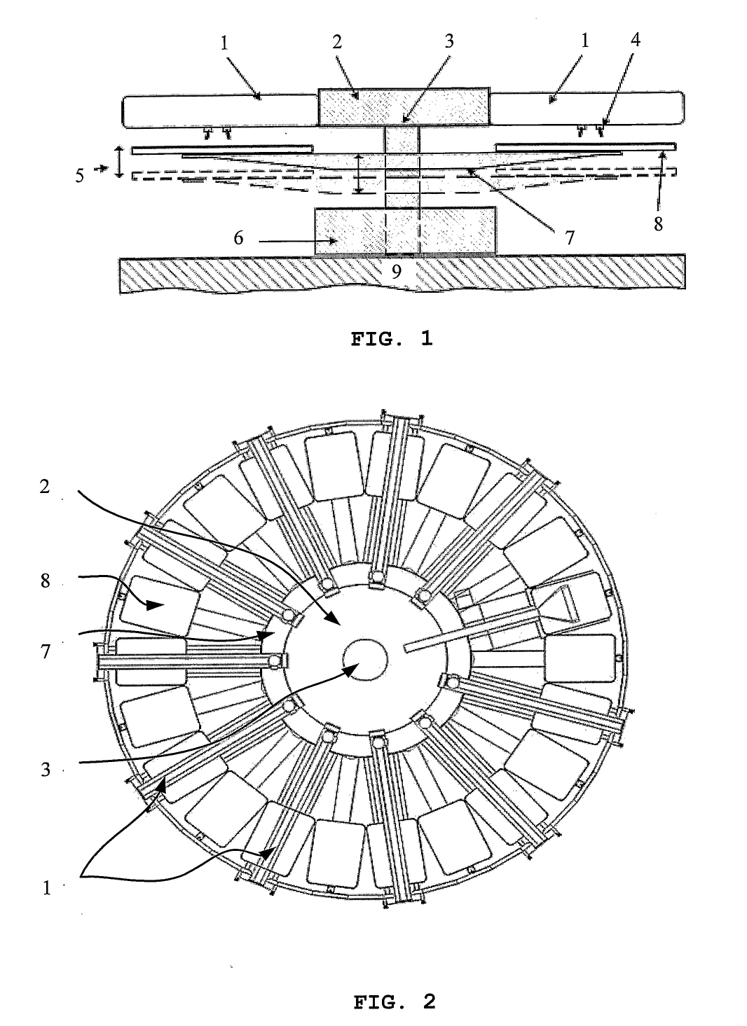

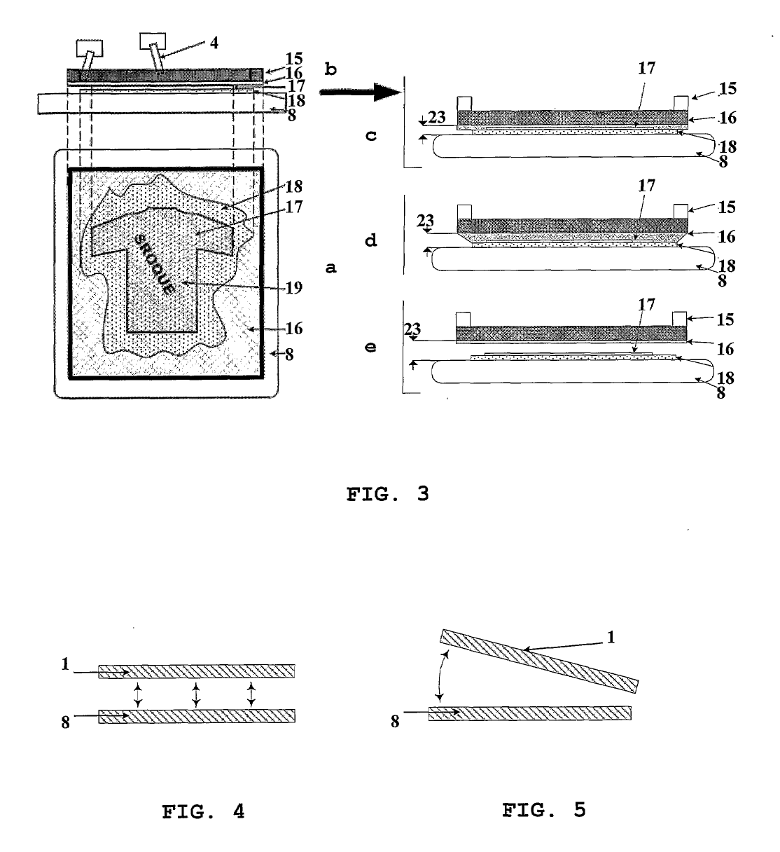

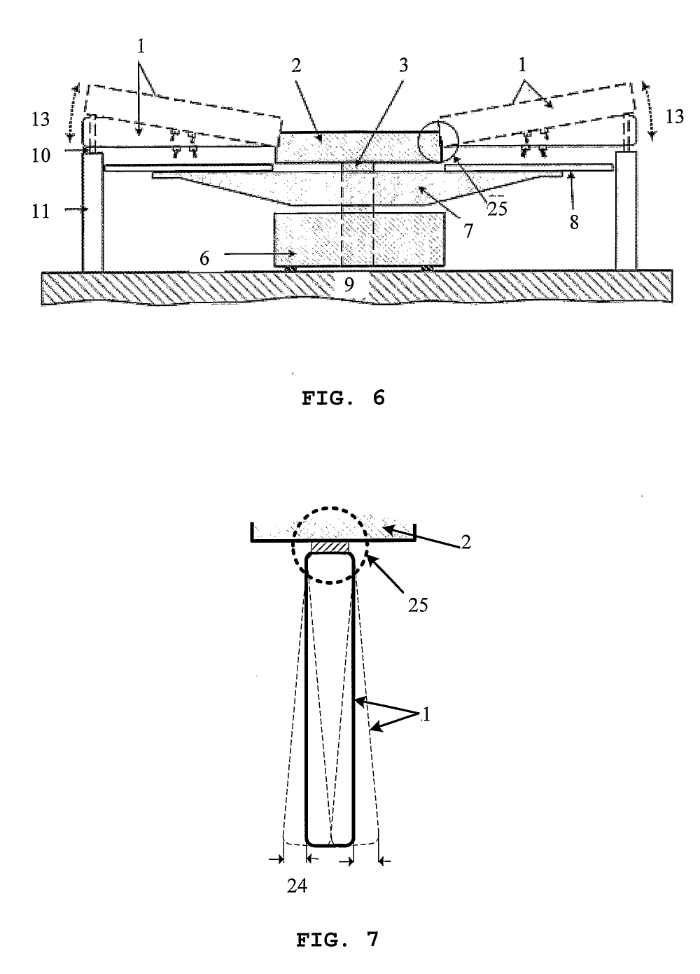

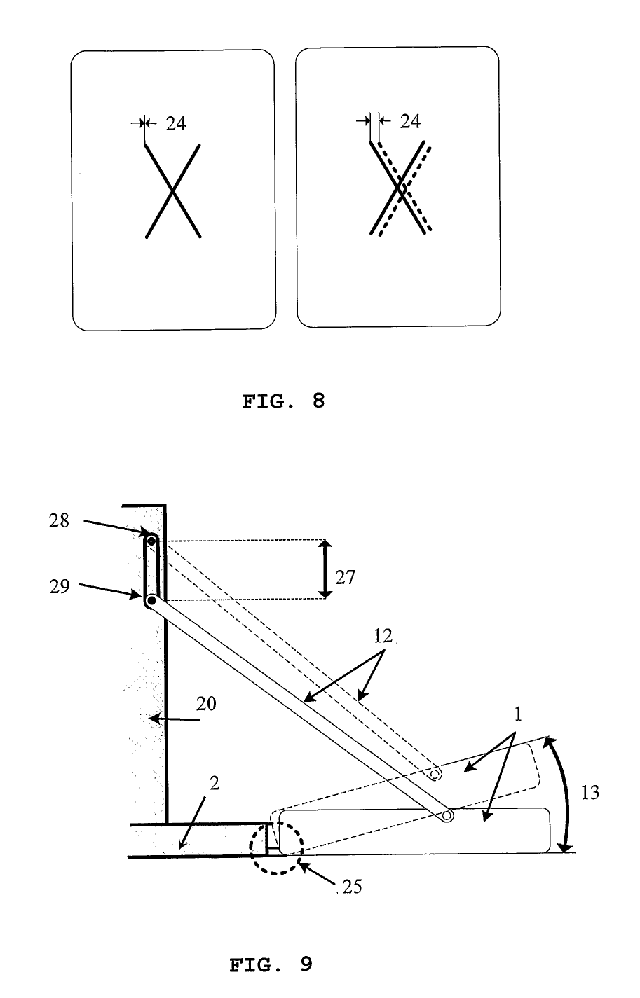

According to the invention, the radial screen printing machine does not have towers, the operation of the correspondent stations (1) being promoted—according to the illustrated in FIG. 9—by rods (12), that articulate, each one of them, in the correspondent station and in another point, point that is susceptible of undergoing a movement (27) that takes it from a first position (28), in which the correspondent station is lifted, to a second position (29), in which that station is lowered. Consequently, the movement (27) of the said point of articulation of the rod (12) originates the angular movement of lowering or lifting (13) of the correspondent station (1), since this is connected to the support (2) by the plane articulation (25) comprising a plate (14) substantially rigid, except in what concerns its capacity of flexing.

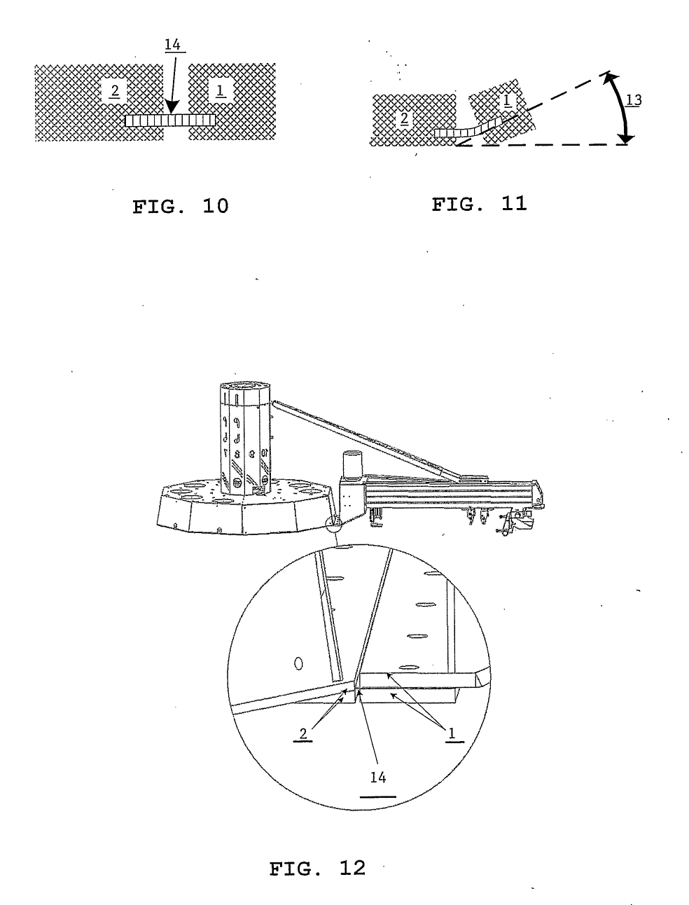

The FIGS. 10, 11 and 12 represent that plate, as well as the schematic operation of the correspondent articulation (25). Each plane articulation thus configured operates as a hinge without plays due to the use of the plate (14) which is a solid body, without mobile parts, rigidly fixed to the support and to the correspondent station. Such plate is made in a metallic alloy or another resilient material and presents high resistance to the traction to make it sufficiently rigid (considering the plane of the plate) but with enough flexibility to allow the angular lifting/lowering movement (13) of the stations. The spacing between the support (2) and the stations (1) will depend on the plate (14), but values until 10 mm have revealed effective.

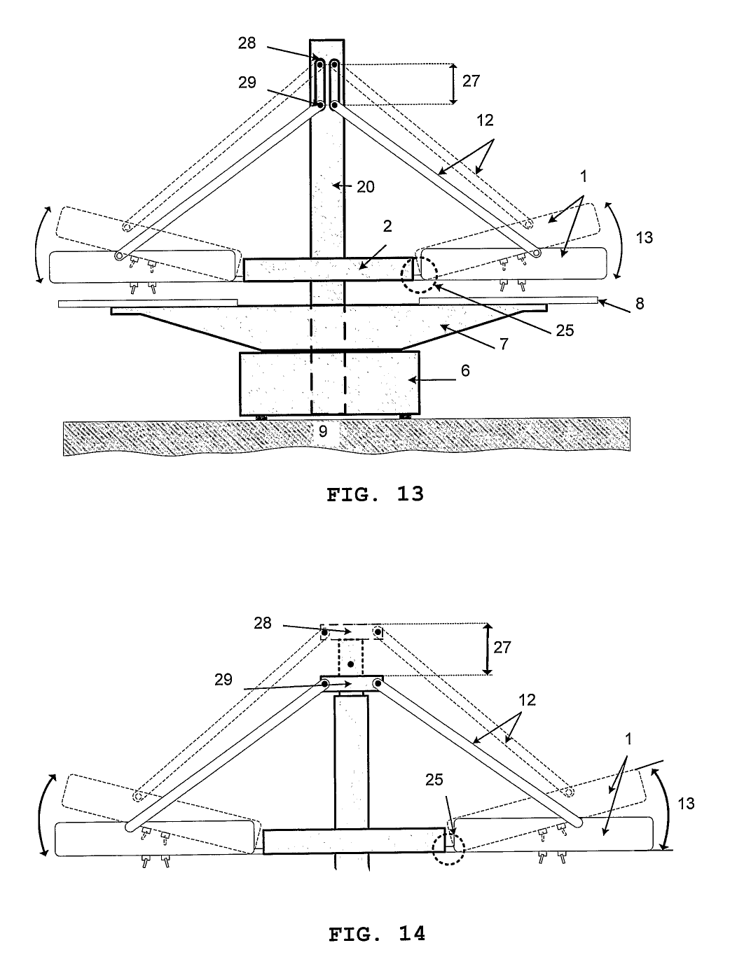

In the machines with individual elevation—see FIG. 13—there is a column or central support (20) to which is autonomously connected each rod (12) of each station (1).

In the individual elevation, the stations (1) have individual actuators—namely electric, pneumatic or hydraulic—actuators that (by simplification not represented in the figure) are preferentially lodged in the column (20), connected to the support (2) of the said stations, and allow to move these individually, by means of the movement (27) of the correspondent rod (12).

When the rod is in the position (29) the station is lowered. As soon as the actuator of the movement (27) is activated the correspondent station (1) initiates an angular movement of elevation, dragged by the rod (12), until this reaches the position (28), the station being then in the highest position, as may be observed in FIG. 13 (in discontinuous line). The movements of the actuators are independent, so the correspondent stations may be moved individually accordingly to a rapid angular lifting/lowering movement (13), being positioned with precision owing to the use of the plane articulations (25) without plays, previously described. The autonomous command of the actuators allows a higher versatility of operation.

In the machines having the stations elevated together—see FIG. 14—each printing station is also provided with a correspondent rod (12), but all the rods articulate in a single actuator. Consequently, the rods and the stations move always at the same time. Although the effort of lifting all the stations falls on a single actuator, as the relative movement between the stations and the correspondent supports is an angular movement (13), the ungluing effort between the serigraphic screens of the said stations and the correspondent articles and platforms is gradual, so that the sum, at each moment, of the individual efforts in each station is much more reduced than the one that would result (and would be necessary the actuator to be able to develop) in the case of another type of lifting (not angular).

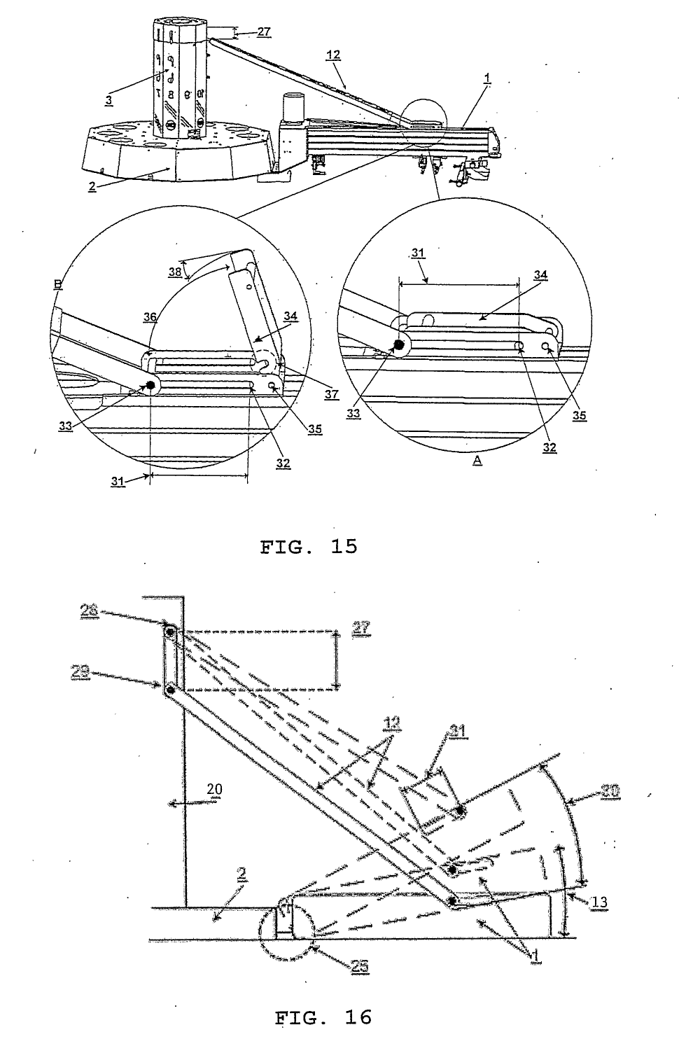

According to a preferential embodiment of the invention, the machine is provided with a mechanism of over-elevation of the stations (1), which allows to perform a supplementary angular movement of lifting/lowering (30). Such mechanism, illustrated in FIGS. 15 and 16, is constituted by a guide (31)—provided with an extreme (33) and an extreme (32)—guide where the fulcrum of the articulation between the station (1) and the correspondent rod (12) may slide between the two positions corresponding to the said extremes, positions where the translation movement of the fulcrum may be blocked, by means of a closing lever (34) provided with a groove (37).

Such mechanism allows the elevation for rest or cleaning of the heads. Preferentially, it is operated manually by the user of the machine (but it may also be automatically) that, for such, operates the lever (34) that rotates around a fulcrum (35), describing an arc (36).

The linear movement along the guide (31) is independent from the linear movement (27) and may be initiated with the rod (12) either in the position (29), or in the position (28).

The movement of the articulation between the rod (12) and the station (1) along the guide (31), until the position (32), forces that station (1) to get higher, allowing to make, namely, the cleaning of the screen frame.

The lever (34) is fixed to the fulcrum (35), which functions as a hinge and allows making the angular movement (36). This lever makes the block of the rod in the position (33) and in the position (32). If the rod is placed in the point (33) the station is in the lower zone, if it is placed in the position (32) the station stays in the higher point. This lever has the peculiarity of having a small angular difference with a radius defined (38) in the mobile extremity that allows to push the extremity of the rod in the point (33) maintaining the rod fixed and without plays in the position (33). This pushing operation occurs when is made the angular movement of the lever, which provokes a force deriving from the angular difference (38) against the bolt of the rod forcing this to always stay in the point (33) during the operation.

The blocking movement is made in the following way: Initially, the lever is concealed, forcing the rod to stay in the point (33). Then, the user pulls the lever (34) up, making the movement (36). The user lifts the printing head, forcing the extremity of the rod (12) and the respective bold to displace to the position (32), translating along the guide (31). Afterwards, lowers the lever (34) to the initial position, with the movement (36), the bolt being blocked in the point (32), due to the groove (37), remaining blocked until the inverse operation is performed.

1. Radial screen printing machine, provided with radially disposed printing stations (1), characterised in that has a relative angular movement of lifting/lowering (13), between the stations and the correspondent platforms (8), whose operation is not promoted by actuators supported in towers (11) and in that the relative angular positioning (24)—considering a plane orthogonal to the axis (3) of the machine—between the said stations (1) and the same correspondent platforms (8), is obtained without resorting to towers (11).

2. Machine according to claim no. 1, characterised in that the stations (1) are operated together, in what concerns their movement of angular lifting/lowering (13).

3. Machine according to claim no. 1, characterised in that the stations (1) are operated individually, in what concerns their movement of angular lifting/lowering (13).

4. Machine according to claim no. 1, characterised in that the plane articulation (25), between each station (1) and the support (2), is constituted by a plate (14) susceptible of flexing rigidly fixed, by the zone correspondent to the respective extremities, to the referred support (2) and to the station (1), plate that is essentially not susceptible of deforming, except in what concerns the bend around an axis parallel to the plane of the respective faces and orthogonal to the radial direction correspondent to the station.

5. Machine according to claim no. 1, characterised in that the movement of angular lifting/lowering (13) of each station (1) is provided by a correspondent rod (12) that articulates in the said station and in another point (fixed or mobile) connected to the support (2) of the stations (1).

6. Machine according to claim no. 1, characterised in that one, several or all the stations have an individual mechanism of over-elevation.

7. Machine according to claim no. 5, characterised in that the over-elevation mechanism promotes either the spacing apart between the points correspondent to the plane articulation between the station (1) and the support (2) and to the articulation between the same station and the correspondent rod (12), or the shortening of the said rod, or still the adequate movement of the point corresponding to the other articulation of the rod.

8. Machine according to claim no. 7, characterised in that the over-elevation mechanism is constituted by a guide (31)—provided with an extreme (33) and an extreme (32)—guide where the fulcrum of the articulation between the station (1) and the correspondent rod (12) may slide between the two positions corresponding to the said extremes, positions where the translation movement of the fulcrum may be blocked, by means of a closing lever (34) provided with a grove (37).

9. Machine according to claim no. 6, characterised in that the over-elevation mechanism promotes either the spacing apart between the points correspondent to the plane articulation between the station (1) and the support (2) and to the articulation between the same station and the correspondent rod (12), or the shortening of the said rod, or still the adequate movement of the point corresponding to the other articulation of the rod.
